(19) United States
(12) Patent Application Publication
(10) Pub. No.: US 2026/0302865 A1
(43) Pub. Date: Oct. 1, 2026

(54) WINDING FOR A STATOR OF AN ELECTRIC MACHINE, COMPRISING A FURTHER INSULATION SURROUNDING AN INDIVIDUAL WIRE INSULATION

(71) Applicant: Schaeffler Technologies AG & Co. KG, Herzogenaurach (DE)

(72) Inventors: Dennis KUHL, Buhl (DE); Holger WITT, Buhl (DE); Dirk Reimnitz, Buhl (DE); Thomas Hurle, Buhlertal (DE); Ivo Agner, Buhl (DE)

(73) Assignee: Schaeffler Technologies AG & Co. KG, Herzogenaurach (DE)

(21) Appl. No.: 19/475,938

(22) PCT Filed: Apr. 8, 2024
(86) PCT No.: PCT/DE2024/100283

§ 371 Date: Oct. 16, 2025

(30) Foreign Application Priority Data
Apr. 19, 2023 (DE) 10 2023 109 867.5

(51) Int. Cl. H02K 3/34; H02K 1/14; H02K 3/18; H02K 3/24; H02K 3/32

(52) U.S. Cl. CPC H02K 3/34; H02K 1/14; H02K 3/18; H02K 3/24; H02K 3/325

(57) ABSTRACT

A winding for a stator of an electric machine, including a wire-like conductor which is wound in the form of a coil, wherein the conductor is surrounded by an individual wire insulation at least in sections, wherein the winding is surrounded by a further insulation in the region of the individual wire insulation. A stator for an electric machine, having at least one tooth, which is surrounded by at least one above-described winding.

### CROSS-REFERENCE TO RELATED APPLICATIONS

This application is the U.S. National Phase of PCT Appln. No. PCT/DE2024/100283, filed Apr. 8, 2024, which claims the benefit of German Patent Appln. No. 102023109867.5, filed Apr. 19, 2023, the entire disclosures of which are incorporated by reference herein.

### TECHNICAL FIELD

The disclosure relates to a winding for a stator of an electric machine, for example an axial flux machine or a radial flux machine, with a conductor in wire form wound as a coil.

### BACKGROUND

In electric machines, different regions have different insulation requirements. While the insulation of individual wires in a coil from each other requires rather low insulation thicknesses, the requirement for insulation between the coil and the housing or between two coils of different phases is significantly higher. The insulation between two wires of a coil tends to be thin, the insulation between the coil and the housing is medium to high, and the insulation between two coils of different phases is also high.

In the prior art, this problem is solved by insulation systems of the following type: wire insulation, base insulation or phase separation. The wire insulation is a PEEK or PAI coating on individual wires. For basic insulation, insulating paper is mainly used as an insert in the slots of the stator. A coil carrier made of injection-molded plastics material can also be used as basic insulation, although this is more likely to be used at lower voltages. In the case of phase separation, insulation can be avoided in the region of the slot by selection of the winding concept and can be solved by insulation paper or plastics moldings in the winding head region. Sometimes the wire insulation is designed to be sufficiently thick or the distance between adjacent coils is chosen to be sufficiently large.

Powder coating of the stator can also be used as insulation. However, the main problems here are sharp edges and application to the complex geometry of the stator.

In contrast to the radial flux machine, the stator of the axial flux machine has a complex geometry. Due to the complex geometry, the stator cannot straightforwardly be insulated using planar insulation materials such as paper or film. Lining the slot with insulating paper is not effective, since at high voltages the required slot spacing between copper and stator lamination to prevent leakage paths leads to a huge reduction in power density. This is because the outer diameter of the stator, which is formed as a laminated stator core, has a disproportionate impact on the achievable torque.

Winding carriers are one solution, especially in applications with lower voltages. Defect-free insulation between two winding carriers is another challenge. In addition, winding carriers must be relatively thick in order to withstand the forces during the winding process. However, this conflicts with the goal of making the insulation as thin as possible in order to generate a maximum copper space factor while at the same time providing space for coolant flow in the grooves of the machine.

### SUMMARY

The object of the present disclosure is to eliminate or at least (partially) alleviate the stated disadvantages.

This is solved in a winding of the type in question by surrounding the winding with further insulation in the region of the individual-wire insulation. The fundamental difference here is that the further insulation is formed not on the stator, but instead directly on the winding itself. This has the advantage that the less complex geometry of the winding simplifies application of further insulation. The further insulation is a separate/distinct/additional/different component from an individual-wire insulation. The conductor in wire form can be formed as an individual-wire or as a stranded wire. The stranded wire is formed by a large number of strands. If the conductor in wire form is a stranded wire, the individual strands each have insulation that encloses the individual strands. Insulation of the stranded wire formed from a large number of strands corresponds to the individual-wire insulation mentioned above. The single wire can be a round wire or a flat wire. A winding is a winding of a material around an axis, in this case a wound wire, that forms a conductor. Because the winding is surrounded by further insulation in a region of the individual-wire insulation, the further insulation can be applied in such a way that the winding has sections where only individual-wire insulation is present, but no further insulation.

Advantageous embodiments are claimed in the dependent claims and are explained in greater detail below.

Furthermore, the further insulation can surround the winding in sections that are not surrounded by the individual-wire insulation. Overall, the conductor can therefore have sections where there is only individual-wire insulation, the further insulation surrounds the individual-wire insulation and/or the further insulation surrounds the winding directly, without individual-wire insulation. This allows for flexible design.

In a preferred embodiment, the thickness of the further insulation is at least between 100 and 300 μm, preferably between 450 and 550 μm, particularly preferably 500 μm and the maximum thickness is preferably 500 to 600 μm. The thickness depends on the operating voltage of the input machine and the maximum thickness depends on the cooling. These thicknesses permit optimum use of the limited installation space.

In addition, the further insulation can form a basic insulation and/or be in the form of an overmolding, film covering, coating, taped covering, wrapping, impregnation, or a dip-painted or sprayed finish. The further insulation can be single-layered or multi-layered. This permits flexible design of the further insulation, as set out in greater detail below. The basic insulation can prevent housing parts from coming into contact with live parts. Accordingly, basic isolation contributes significantly to the protection of people.

Furthermore, the overmolding can be made of a thermoplastic material. This is advantageous because a thermoplastic has good processing properties, allows deformation in certain temperature ranges and, after cooling, has a solid state that can be reversibly processed again by heating.

The overmolding can be produced in a multistage process. It is particularly advantageous for the multi-stage process to have two stages. In a first stage, an initial overmolding is provided around the winding while the winding is still on a winding mandrel. The second stage of overmolding is then carried out when the winding mandrel has been removed and the outer overmolding tool maintains the outer contour. This results in a very small positioning tolerance of the winding within the overmolding.

The film covering can be produced by thermoforming, sheet forming, vacuum forming or wrapping. This allows for flexible design of the film covering.

In a further advantageous embodiment, the coating is in the form of a powder coating. This makes it possible to achieve very thin layer thicknesses.

It is advantageous for the further insulation to completely enclose the winding and for only an initial piece and a final piece to be exposed. This ensures that the windings can be connected to each other.

In addition, the further insulation can form at least one functional element, in particular a spacer, and/or the further insulation can surround or enclose or fix in place at least one functional element, in particular a pole shoe. The functional elements offer the possibility of implementing further aspects/functions by way of the further insulation. This offers the advantage that optimum use is made of the little installation space that is available.

In one advantageous embodiment, the spacers are an integral part of the further insulation. The spacers are formed in the overmolding process, for example, and separate methods can be dispensed with. Provision as an integral component also prevents detachment from the further insulation.

Alternatively, the spacers can be formed as separate elements on the further insulation. For this purpose, the further insulation is prepared such that the spacers can be attached. For example, the spacers can be attached to the further insulation using an adhesive or other comparable curable material. This means that the spacers can also be added after the manufacturing process. This enables a more flexible design.

In addition, the spacer can be configured to define a coolant contour. The spacers are preferably made slanted or curved in shape so that the coolant flow can be influenced/guided.

In addition, the spacer can be formed as a bead on the outer side of the further insulation. Preferably, the base insulation has a number of spacers on the outer side. This creates a large number of preferably rounded elevations that serve to guide the coolant.

Furthermore, the spacers formed on the inside of the further insulation can be interrupted, i.e., not formed over the entire length. This promotes coolant flow.

In a further advantageous embodiment, further functional elements in the form of fastening elements can be provided. The fastening elements can be in the form of clips that protrude radially inward and/or radially outward and are shaped to engage with the stator yoke. Alternatively, the fastening elements can be tabs that can be screwed or riveted. Overall, this ensures that the winding is additionally secured on the stator.

It is particularly preferred for the material for producing the further insulation to have fillers. These can be, for example, ceramic, granite or silver ions for greatly increased thermal conductivity.

It is advantageous for the pole shoe to be provided as a supplement to a tooth to be surrounded by the winding. This allows the magnetic field lines of the winding formed into a coil to emerge and be distributed in a defined shape.

The disclosure also provides a stator for an electric machine that has at least one tooth surrounded by at least one winding as described above.

The disclosure also provides an electric machine with a stator as described above which is operatively related to a rotor.

It is preferred for the electric machine to be an axial flux machine or radial flux machine.

In other words, the disclosure relates to a sheathing/further insulation of a winding before installation in an electric machine. The further insulation can be applied to the winding like a skin. In addition, the winding wire can already have an individual-wire insulation, for example 50 μm PAI, before the winding is manufactured. In addition, the material of the further insulation may contain fillers/additives that promote thermal conduction, for example aluminum oxide, ceramic, granite.

In addition, the further insulation can have elevations/spacers on the surface that provide spacing and positioning of the winding in relation to the laminated core, form cooling channels and protect the insulation from abrasion during installation. The elevations on the surface are embodied in such a way that they guide the coolant flow along the surface of the further insulation.

Furthermore, fixing elements/fastening elements in the form of clips and/or tabs can be integrated into the further insulation in order to fix the winding in place.

Pole shoes can also be integrated into the further insulation. Furthermore, the further insulation can be applied using a plastics injection molding process. The plastics material can be, for example, a thermoplastic or thermosetting material. The further insulation can also be applied by a coating process, for example powder coating. In addition, the sheathing can be provided by applying a film, for example by thermoforming, vacuum forming or wrapping. Furthermore, the film can have a baking varnish that is baked after application.

### BRIEF DESCRIPTION OF THE DRAWINGS

An advantageous embodiment of the disclosure is explained in greater detail below with reference to a drawings with figures.

### In the Figures:

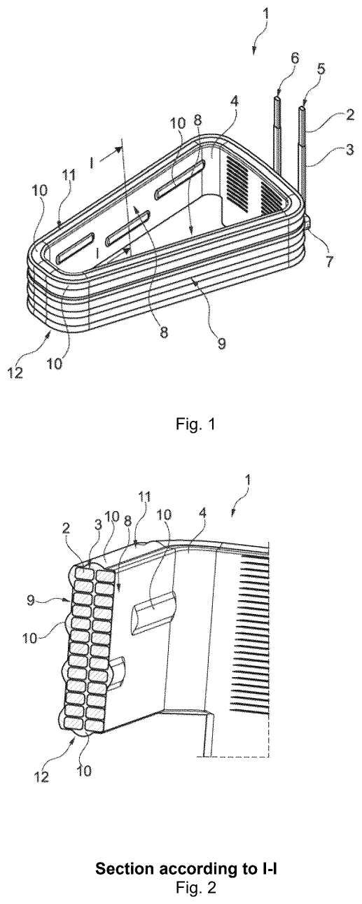

FIG. 1 shows a perspective view of a winding according to the disclosure with further insulation surrounding an individual-wire insulation,

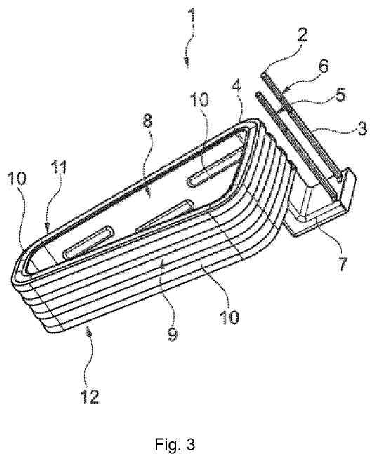

FIG. 2 shows a sectional view of the winding according to the disclosure according to FIG. 1 along the section line I-I,

FIG. 3 shows a perspective rear view of the winding according to the disclosure according to FIG. 1.

### DETAILED DESCRIPTION

The figures are merely schematic in nature and serve solely for understanding the disclosure. Identical elements are provided with the same reference symbols. Features of the individual embodiments can be interchanged and used alternatively/cumulatively.

FIGS. 1 to 3 show a winding 1 according to the disclosure for a stator of an electric machine, an axial flux machine or a radial flux machine, with a conductor 2 in wire form wound as a coil, wherein the conductor 2 is surrounded at least in sections by an individual-wire insulation 3. It should be noted that the winding 1 is surrounded by further insulation 4 in the region of the individual-wire insulation 3. In the illustrated embodiment, the further insulation 3 is provided by way of an overmolding.

The conductor 2 has an initial piece 5 and a final piece 6. These two pieces 5, 6 are surrounded neither by the further insulation 4 nor by the individual-wire insulation 3. In the illustrated embodiment of the winding 1, the initial piece 5 and the final piece 6 are positioned in a holding element 7 such that the initial piece 5 and the final piece 6 point upward as shown. In the embodiment shown, the holding element 7 is formed on the rear side by way of the overmolding (see FIG. 3).

The winding 1 surrounded by the overmolding has two inner sides 8 and an outer side 9. The inner sides 8 are oriented toward the side faces of a stator tooth (not shown) and the outer side 9 is the outer face of the further insulation 4. Spacers 10 are formed on the inner sides 8. In the illustrated embodiment, the spacers 10 are an integral part of the further insulation 4. In the present embodiment, the spacers 10 are not formed over the entire length of the inner side 8, but are shaped and positioned in sections. In total, the illustrated embodiment has three spacers 10 per inner side 8, which are positioned offset from one another. In the embodiment shown, two spacers 10 are positioned in one row and a third spacer 10 is positioned in a second row.

These spacers 10 help to form a coolant contour on the inside.

A large number of spacers 10 are formed on the outer side 9. These spacers 10 are shaped like a bead and are formed circumferentially around the further insulation 4.

A section through the winding 1 with the further insulation 4 is made along section line I-I (according to FIG. 1), and shown in greater detail in FIG. 2. The spacers 10 on the outer side 9 of the further insulation 4 are formed at a uniform distance from one another and the spacers 10 have a curved shape. In addition to the spacers 10 on the inner side 8 and the outer side 9, spacers 10 are also formed on an upper side 11 and a lower side 12.

### LIST OF REFERENCE SIGNS

1 Winding
2 Conductor
3 Individual-wire insulation
4 Further insulation
5 Initial piece
6 Final piece
7 Retaining element
8 Inner side
9 Outer side
10 Spacer
11 Upper side
12 Lower side

1. A winding for a stator of an electric machine comprising:
a conductor in wire form which is wound as a coil,
wherein the conductor is surrounded by a single-wire insulation at least in sections, and
the winding is surrounded by a further insulation in a region of the ingle-wire insulation.

2. The winding according to claim 1,
wherein the further insulation forms a basic insulation or is in the form of at least one of an overmolding, film covering, coating, taped covering, wrapping, impregnation, or a dip-painted or sprayed finish.

3. The winding according to claim 2, wherein the coating is in the form of a powder coating.

4. The winding according to claim 1, wherein the further insulation encloses the winding such that only an initial piece and a final piece are exposed.

5. The winding according to claim 1, wherein the further insulation forms at least one functional element.

6. The winding according to claim 5, wherein the at least one functional element includes a spacer, and wherein the spacer is configured to define a coolant contour.

7. The winding according to claim 6, wherein the spacer is formed as a bead on an outer side of the further insulation.

8. The winding according to claim 17, wherein the at least one functional element includes a pole shoe, and wherein the pole shoe is provided as a supplement to a tooth to be surrounded by the winding.

9. A stator for an electric machine, having at least one tooth surrounded by at least one winding according to claim 1.

10. An electric machine comprising:
a stator operatively related to a rotor;
wherein the stator has at least one tooth surrounded by at least one winding,
wherein the winding includes a conductor in wire form which is wound as a coil,
wherein the conductor is surrounded by a single-wire insulation at least in sections, and
wherein the winding is surrounded by a further insulation in a region of the single-wire insulation.

11. The electric machine according to claim 10, wherein the further insulation forms a basic insulation or is in the form of at least one of an overmolding, film covering, coating, taped covering, wrapping, impregnation, or a dip-painted or sprayed finish.

12. The electric machine according to claim 11, wherein the coating is in the form of a powder coating.

13. The electric machine according to claim 10, wherein the further insulation encloses the winding such that only an initial piece and a final piece are exposed.

14. The electric machine according to claim 10, wherein the further insulation forms at least one functional element.

15. The electric machine according to claim 14, wherein the at least one functional element includes a spacer, and wherein the spacer is configured to define a coolant contour.

16. The electric machine according to claim 15, wherein the spacer is formed as a bead on an outer side of the further insulation.

17. The winding according to claim 1, wherein the further insulation surrounds or encloses or fixes in place at least one functional element.
